(19) United States
(12) Patent Application Publication
(10) Pub. No.: US 2008/0130276 A1
(43) Pub. Date: Jun. 5, 2008

(54) Screen table lamp

(76) Inventor: Daniel Edelist, Venice, CA (US)

Correspondence Address: DANIEL EDELIST, 349 6th AVENUE, VENICE, CA, 90291, US

(21) Appl. No.: 11/633,140

(22) Filed: Dec. 4, 2006

(51) Int. Cl. F21S 4/00; B60Q 1/00

(52) U.S. Cl. 362/224

(57) ABSTRACT

Screen table lamp with a rigid rectangular frame constructed of inwardly facing U shaped frame members, a T5/830 type fluorescent light bulb, a pair of translucent screen members, each capable of filling the front and rear space formed by the frame, a plurality of screen supporting brackets, a frame supporting base, a standard fluorescent bulb socket and a power cord and attached plug an on off switch. The fluorescent bulb is mounted longetudinally inside one side of the U shaped longitudinal frame member. The frame is mounted to the base. The bulb socket is wired to the power cord and the switch, so that when the power plug is inserted into a standard wall socket and the switch is turned on, the translucent screen members are illuminated relatively evenly along their entire surface. The side dimension of the frame can be as little as one inch.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable table lamps and more specifically to slim profile screen table lamp.

Portable table lamps are well known. There are many styles of lamps and a variety of lighting sources available for use today.

One type of lighting means is a fluorescent tube, these tubes are efficient and can produce a pleasing light. However, the light itself is unsightly to look at.

Fluorescent tube lights have been used in table lamps. Generally they are task type lamps where one side of the bulb is exposed and the opposite side is covered by a cover to shield the viewers eyes from the direct light coming from the bulb.

However, attempts to use a fluorescent lighting tube within a slim decorative table lamp have been frustrated because if the bulbs are placed too close to a translucent diffusing panel, they present unsightly bright spots. Additionally, traditional fluorescent tubes are over one inch in diameter thereby further frustrating the ability to create a thin profile table lamp.

### BRIEF SUMMARY OF THE INVENTION

The primary object of the invention is to provide a slim profile table lamp that incorporates a pair of illuminated screens that are lit in such a way that the lighting means is totally hidden from view.

Another object of the invention is to provide a table lamp that is slim in side width yet produces an even illuminating glow along its front and rear screen panels.

A further object of the invention is to provide a table lamp where one illuminated screen can be seen from both the front of the lamp and one illuminated screen can be seen from the rear of the lamp.

Yet another object of the invention is to provide a table lamp whose side profile is thinner than traditional lamps.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a screen table lamp comprising: a rigid rectangular frame constructed of inwardly facing U shaped frame members, a T5/830 type fluorescent light bulb, a pair of translucent screen members, each capable of filling the front and rear space formed by said frame, a plurality of screen support brackets, a frame supporting base, a standard fluorescent bulb socket a power cord and attached plug and on off switch, said fluorescent bulb mounted longetudinally inside one side of said U shaped longitudinal frame member, said frame mounted to said base, said bulb socket wired to said power cord and said switch, so that when a user plugs in said power plug into a standard wall socket and turns on said switch, said translucent screen members are illuminated relatively evenly along their entire surface. Said base portion includes a heavy metal member adding stability to said base and said attached screen frame. The side width dimension of said frame can be as little as one inch but is preferably three inches. Each said screen is comprised of a sheet of translucent styrene plastic with a sheet of fabric laminated to said styrene.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a front plan view of the invention.

FIG. 2 is a side section view of the invention.

FIG. 3 is a top section view of the invention.

FIG. 4 is a side view of the invention.

FIG. 5 is a rear plan view of the invention.

FIG. 6 is a top view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

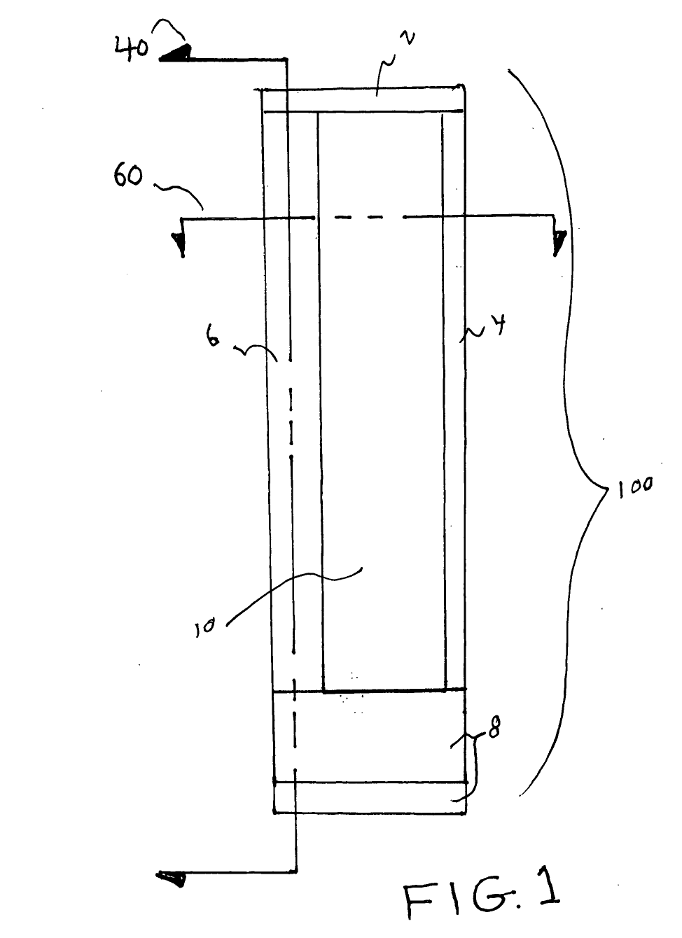

Referring to FIG. 1 we see a front view of the invention 100. A rectangular frame is made up of U shaped frame members 2, 4, 6, 8.

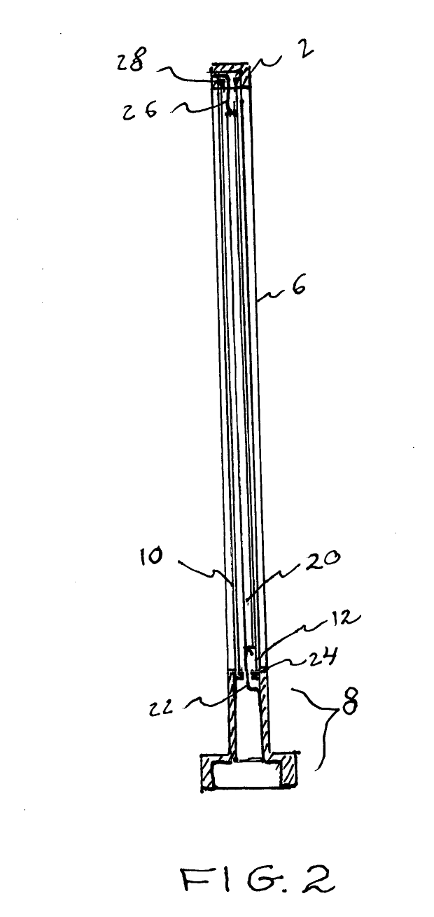

Bottom frame member 8 acts as a base. A translucent screen 10 fills the space created by the frame members 2, 4, 6, 8. FIG. 2 shows a side section of the invention as defined by section line 40. A T8/830 type fluorescent bulb 20 is longitudinally located within the U shaped frame member 6. Because the bulb has a relatively thin diameter of five eights of an inch, the resulting U shaped frame 2, 4, 6, 8 can be thin in side profile. the bulb 20 radiates light so that the front 10 and rear 12 translucent screen panels are illuminated evenly with no bright spots since the bulb 20 is not directly behind the screens 10, 12. Standard holding brackets 24, 28 hold the screens in place. Standard bulb contacts 22, 26 hold bulb 20 in place and allow it to receive power from a standard wall outlet via power cord 14, 18 and plug 18 when switch 16 is turned to the “on” position by the user. Base frame member 8 is constructed of heavy material such as cast metal, so that the lamp will not tip over easily.

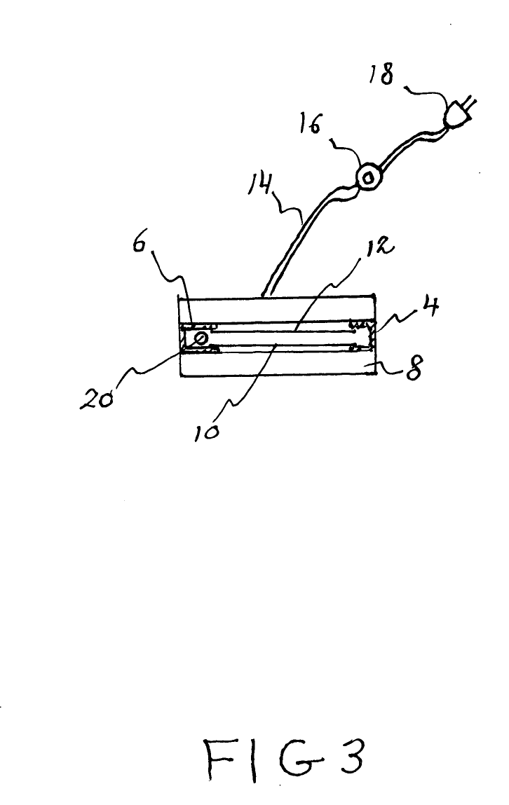

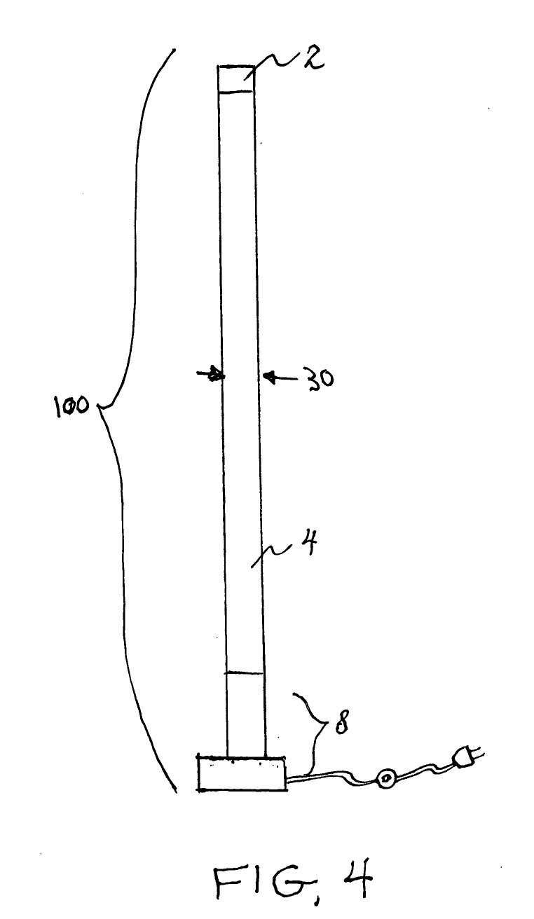

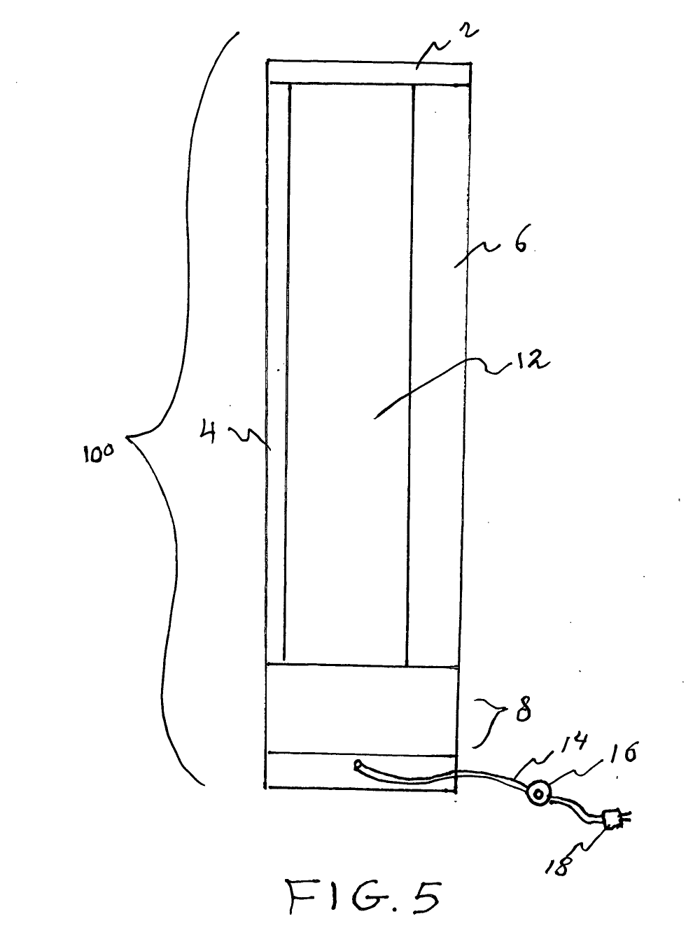

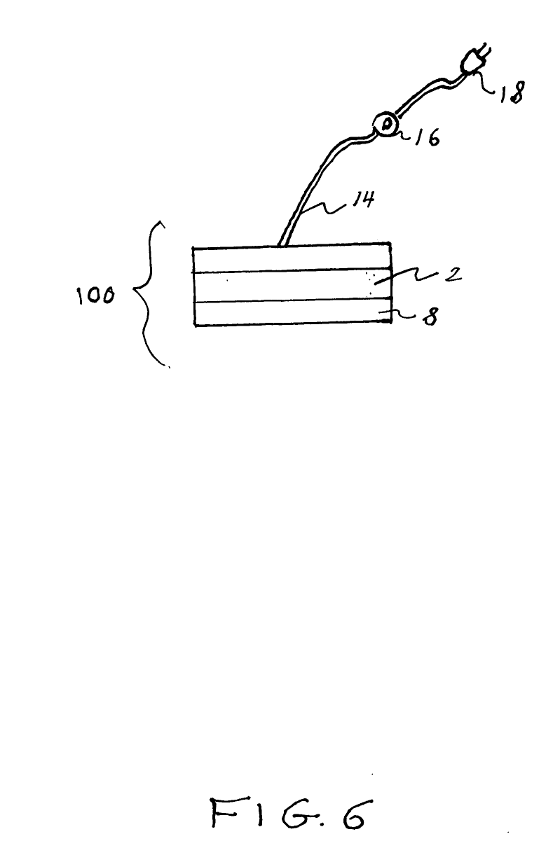

FIG. 3 shows a top section view as defined by section line 60. In this view, fluorescent bulb 20 is clearly seen placed within the confines of U shaped frame member 6. FIG. 4 shows a left side view of the invention 100. The right side is a mirror image of the left side. Because of the thin nature of the fluorescent bulb 20, and because the bulb is to the side of screen members 10, 12 rather than behind them, the overall width, as shown by dimension arrows 30 side frame 4 can be as little as one inch, but is more typically approximately three inches. FIG. 5 is a rear view of the present invention 100. FIG. 6 is a top view of the present invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1-4. (canceled)

5. A screen table lamp comprising:
a pair of short elongate rigid frame members;
a pair of long elongate rigid frame members;
a pair of translucent rectangular screen panels;
a T5 fluorescent light bulb;
a plurality of standard panel supporting brackets;
a frame supporting base portion;
a T5 fluorescent bulb socket;
a power cord and attached plug;
an on-off switch;
said short frame members and said long frame members each having a U shaped cross sectional configuration.
said short frame members forming the top and bottom of a rectangular frame and said long frame members forming the left and right sides of said rectangular frame;
said short and said long frame members being fixedly attached to each other so that the base of each said U shaped cross sectional member forms the outer most perimeter of said rectangular frame;
said T5 fluorescent bulb and said bulb socket residing within the confines of said U shaped cross sectional area of one said long frame member;
said rectangular translucent screen panels being sized to fit within said rectangular frame so that each said screen panel lays against the inner surface of the inwardly facing legs of said U shaped cross sectional frame members and held in place by means of said standard panel supporting brackets;
said panel supporting brackets fixedly attached to the inner surfaces of the inwardly facing portion of said U shaped cross sectional frame members; said frame and said screen panel configuration resulting in a rectangular hollow housing where said rigid U shaped frame members form the perimeter walls of said housing and said screen panel members form the front and rear walls of said housing;
said power cord, said on-off switch and said plug attached to said fluorescent socket in a standard way;
said cord exiting an aperture in one said rigid frame member;
said rectangular frame attached to and supported by said frame supporting base portion.

6. Screen table lamp as claimed in claim 5 wherein said base portion includes a heavy metal member for adding stability to said base portion and said attached frame.

7. Screen table lamp as claimed in claim 5 wherein the side dimension of said frame can be as little as one inch.

8. Screen table lamp as claimed in claim 5 wherein each said screen panel is comprised of a sheet of translucent styrene plastic with a sheet of fabric laminated to said styrene.
